(19) United States
(12) Patent Application Publication
(10) Pub. No.: US 2014/0047233 A1
(43) Pub. Date: Feb. 13, 2014

(54) SYSTEM AND METHODS FOR AUTOMATED TRANSACTION KEY GENERATION AND AUTHENTICATION

(71) Applicants: Jeffrey T. Kalin, Bala Cynwyd, PA (US); Moses Mwendwa Kimanzi, Hoboken, NJ (US)

(72) Inventors: Jeffrey T. Kalin, Bala Cynwyd, PA (US); Moses Mwendwa Kimanzi, Hoboken, NJ (US)

(21) Appl. No.: 13/955,588

(22) Filed: Jul. 31, 2013

Related U.S. Application Data
(60) Provisional application No. 61/680,547, filed on Aug. 7, 2012.

(51) Int. Cl. H04L 29/06; H04L 9/08

(52) U.S. Cl. CPC H04L 63/083; H04L 9/0861
USPC 713/155

(57) ABSTRACT

An independent, centralized token service that generates and authenticates transactions keys. The keys may be exchanged amongst registered users for use in a versatile variety of transactions and/or as a means of identification, authentication, and/or authorization. The service enables customization and recipient designation of the keys, as well as multi-party, multi-directional, multi-key exchanges.

### CROSS-REFERENCE TO RELATED APPLICATION

This utility application claims the benefit under 35 U.S.C. §119(e) of Provisional Application Ser. No. 61/680,547 filed on Aug. 7, 2012, entitled System and Methods for Automated Transaction Key Generation and Authentication. The entire disclosure of this provisional application is incorporated by reference herein.

### FIELD OF INVENTION

The invention relates generally to the field of authentic transactions and particularly to the automation of transaction key generation and authentication to facilitate such transactions.

### SUMMARY

In an aspect of the invention, there is disclosed a method for automating transaction key generation, exchange, and authentication. The method includes the following steps:

A) an originator logging into a centralized token service by using a first user primary identifier and associated password, and correctly answering a first challenge presented by the centralized token service, and requesting a first transaction key from the centralized token service by, naming a receiver and specifying a first set of parameters for a first transaction key; B) the centralized token service generating a first transaction key according to the first set of parameters and transmitting the first transaction key to the originator; C) the originator transmitting an alias identifier and the first transaction key to the receiver and requesting a transaction; D) the receiver logging into the centralized token service by using a second user primary identifier and associated password, and answering a second challenge, and making a request for authentication, the request comprising the alias identifier and the first transaction key; E) the centralized token service confirming or denying the authenticity based upon a combination of the identifiers and the first transaction key; F) and the receiver completing the transaction separate from the centralized token service

In a further aspect of the above-described invention, at least one of the originator or receiver comprises plural individual users and more than one user login is required to complete at least one of Steps A and D.

In a further aspect of the above-described invention any user of the centralized token service may act as the originator or the receiver for the transaction.

In a further aspect of the above-described invention the centralized token service may be used for one or more applications selected from the list including: identity authentication; transaction authorization; electronic signature; electronic voting; identity authentication login via the internet; identity authentication login via the telephone; secure document transfer; secure password transfer; secure document, file, and/or folder cloud storage; document, file, and or folder encryption; banking services and wire transfers; payment authorization and confirmation; random credit card CVV code generation; online notary services; online witness services; online process server; online registered agent services; document, file, and/or folder delivery confirmation; transaction completion confirmation; transaction activity audit services; transaction delegation; sticky code transactions; or transaction key encryption.

In a further aspect of the above-described invention the alias identifier is identical to the first user primary identifier.

In a further aspect the above-described invention includes the additional steps of the centralized token service storing a parcel of data at the request of the originator and the receiver obtaining the parcel upon presentation of a parcel identifier.

In a further aspect of the above-described invention the centralized token service fulfills the transaction.

In a further aspect of the invention, there is disclosed a method for automating transaction key generation, exchange, and authentication. The method includes the following steps: A) an originator transmitting a first alias identifier to a receiver and requesting a transaction in conjunction with a fourth party; B) the originator logging into a centralized token service by using a first user primary identifier and associated password, and correctly answering a first challenge presented by the centralized token service, and requesting a first transaction key from the centralized token service by, naming a receiver and associated fourth party and specifying a first set of parameters for the first transaction key; C) the centralized token service generating the first transaction key according to the first set of parameters and transmitting the first transaction key to the originator; D) the receiver logging into the centralized token service by using a second user primary identifier and associated password, and correctly answering a second challenge presented by the centralized token service, and requesting a second transaction key from the centralized token service by naming the originator and the associated fourth party and specifying a second set of parameters for the second transaction key; E) the centralized token service generating the second transaction key according to the second set of parameters and transmitting the second transaction key to the receiver; F) the originator transmitting the first alias identifier and the first transaction key to the associated fourth party and requesting a transaction; G) the receiver transmitting a second alias identifier and the second transaction key to the associated fourth party and requesting the transaction; H) the associated fourth party logging into the centralized token service by using a third user primary identifier and associated password, and answering a third challenge, and making a request for authentication, the request comprising of first and second alias identifiers and the first and second transaction keys; I) the centralized token service confirming or denying the authenticity based upon a combination of the alias identifiers and the transaction keys; and J) the associated fourth party completing the transaction separate from the centralized token service.

In a further aspect of the above-described invention at least one of said originator, receiver, or fourth party comprises plural individual users and more than one user login is required to complete at least one of Steps B, D and H.

In a further aspect of the above-described invention any user of the centralized token service may act as the originator, receiver, or fourth party for the transaction.

In a further aspect of the above-described invention the centralized token service may be used for one or more applications selected from the list including: identity authentication; transaction authorization; electronic signature; electronic voting; identity authentication login via the internet; identity authentication login via the telephone; secure document transfer; secure password transfer; secure document, file, and/or folder cloud storage; document, file, and or folder encryption; banking services and wire transfers; payment authorization and confirmation; random credit card CVV code generation; online notary services; online witness services; online process server; online registered agent services; document, file, and/or folder delivery confirmation; transaction completion confirmation; transaction activity audit services; transaction delegation; sticky code transactions; or transaction key encryption.

In a further aspect of the above-described invention, the alias identifier is identical to the first user primary identifier.

In a further aspect, the above-described invention includes the additional steps of the centralized token service storing a parcel of data at the request of the originator and the receiver obtaining the parcel upon presentation of a parcel identifier.

In a further aspect of the above-described invention the centralized token service fulfills the transaction.

In a further aspect of the invention, there is disclosed a method for automating transaction key generation, exchange, and authentication. The method includes the following steps: A) an originator logging into a centralized token service by using a user primary identifier and associated password, and correctly answering a first challenge presented by the centralized token service, and requesting a first transaction key from the centralized token service by, naming a receiver and an associated fourth party and specifying a first set of parameters for the first transaction key; B) the centralized token service generating the first transaction key according to the first set of parameters and transmitting the first transaction key to the originator; C) the originator transmitting a first alias identifier and the first transaction key to the receiver and requesting a transaction in conjunction with the associated fourth party; D) the receiver logging into the centralized token service by using a second user primary identifier and associated password, and correctly answering a second challenge presented by the centralized token service, and requesting a second transaction key from the centralized token service by naming the first alias identifier and the associated fourth party and specifying a second set of parameters for the second transaction key; E) the centralized token service generating the second transaction key according to the second set of parameters and transmitting the second transaction key to the receiver; F) the receiver transmitting the first alias identifier, a second alias identifier, and the first and second transaction keys to the associated fourth party and requesting the transaction; G) the associated fourth party logging into the centralized token service by using a third user primary identifier and associated password, and answering a third challenge, and making a request for authentication, the request comprising of the first and second alias identifiers and the first and second transaction keys; H) the centralized token service confirming or denying the authenticity based upon a combination of the alias identifiers and the transaction keys; and I) the associated fourth party completing the transaction separate from the centralized token service.

In a further aspect of the above-described invention, the originator, receiver, or fourth party comprises plural individual users and more than one user login is required to complete at least one of Steps A, D and G.

In a further aspect of the above-described invention, any user of the centralized token service may act as the originator, receiver, or fourth party for the transaction.

In a further aspect of the above-described invention, the centralized token service may be used for one or more applications selected from the list including: identity authentication; transaction authorization; electronic signature; electronic voting; identity authentication login via the internet; identity authentication login via the telephone; secure document transfer; secure password transfer; secure document, file, and/or folder cloud storage; document, file, and or folder encryption; banking services and wire transfers; payment authorization and confirmation; random credit card CVV code generation; online notary services; online witness services; online process server; online registered agent services; document, file, and/or folder delivery confirmation; transaction completion confirmation; transaction activity audit services; transaction delegation; sticky code transactions; or transaction key encryption.

In a further aspect of the above-described invention, the alias identifier is identical to the first user primary identifier.

In a further aspect, the above-described invention includes the additional steps of the centralized token service storing a parcel of data at the request of the originator and the receiver obtaining the parcel upon presentation of a parcel identifier.

In a further aspect of the above-described invention, the centralized token service fulfills the transaction.

In a further aspect of the invention, there is disclosed a centralized token system for facilitating transaction key generation, exchange, and authentication. The system includes:

a digital computer connected to a digital communications network, the digital computer comprising including a digital computer processor and a memory, input and output devices, and software, wherein the digital computer is configured to: provide a secure login to an originator; generate a first transaction key according to a set of parameters provided by the originator, and provide the first transaction key to the originator; provide a secure login to a receiver; confirm or deny the authenticity of a second transaction key provided by the receiver based on whether the second transaction key is identical to the first transaction key provided to the originator and whether the receiver properly identifies the originator; generate a second transaction key according to a set of parameters provided by the receiver, and provide the second transaction key to the receiver; provide a secure login to a fourth party; and confirm or deny the authenticity of a first and second transaction key provided by the fourth party based on whether the first and second transaction keys are identical to the first transaction key provided to the originator and the second transaction key provided to the receiver and whether the fourth party properly identifies the originator and receiver.

### BACKGROUND OF THE INVENTION

In today's technological world, parties can conduct transactions without being in each other's physical presence. This allows for great efficiency and expediency, but also creates opportunities for fraud. A thief, for instance, may steal your credit card and make an online purchase while posing as you. The ability to authenticate the identity of each participating party has become paramount.

Various methods and technologies, from the simple to the more advanced, exist to aid in identity authentication. These include, for example: username and passwords, card verification value (CVV) codes on credit cards, security questions, return phone calls to registered numbers, etc. However, none are absolutely effective, as evident by the billions of dollars of losses each year from fraudulent transactions and stolen identities.

In enterprise environments, two-factor authentication token systems have emerged as an effective identity authentication tool. Primarily used at network logins, token systems provide an extra layer of security, since the party identifies himself by presenting an extra authentication factor: something the party has, knows or is. For example, EMC Corporation's RSA SecurID token technology enables a company to authenticate the identity of its employee who is requesting access to its network. The employee, who has a RSA token and knows his PIN, submits a one-time generated password to be time-matched against the company's RSA authenticator as extra evidence of his identity.

Token systems have been heavily adopted in some industries; however, they have deficiencies. First, they are expensive. Hardware requirements, maintenance costs, and proprietary product licensing fees limit token system adoption to large enterprises and security-sensitive industries. Second, authentication is completed “in-house”, exposing the process to both external and internal hacking. Third, scalability is restricted: given the nature of today's systems, if a party needs to log in at four different networks, he will need four different tokens. This becomes cumbersome and expensive, inhibiting the expansion of token system use.

Finally, the most significant deficiency is that token systems lack versatility. A token can only generate a one-time password for a pre-assigned one-way single-transaction exchange with a single receiving party. For example, the employee cannot use his RSA token for any use or any receiving party, other than a login identity authentication transaction with his corporation. This drastically reduces its function.

There is a need for a token system that overcomes these deficiencies and opens up its added-security benefit to a wide array of transactions and market reach. There is a need for a token system, accessed centrally through various technologies, that delivers an independent, secure, cost-effective, mass-market (enterprise and consumer) platform. There is a need for a token system facilitating transactions between multiple parties with no pre-assigned role or directional relationships. And there is a need for a token system with versatility of function and output, enabling a wide variety of transactions beyond just identity authentication. The subject invention addresses these needs.

### DESCRIPTION OF THE DRAWINGS

FIG. 1 is a schematic representation of communications in a system in accordance with the invention wherein two users generate, exchange, and authenticate transaction keys using a third-party centralized token service.

FIG. 2 is a schematic representation of communications in a system in accordance with the invention wherein two users and a fourth party generate, exchange, and authenticate transaction keys using a third-party centralized token service and the parties are all in contact with the fourth party.

FIG. 3 is a schematic representation of communications in a system in accordance with the invention wherein two users and a fourth party generate, exchange, and authenticate transaction keys using a third-party centralized token service and the receiver and centralized token service are in contact with the fourth party.

FIG. 4 is a representation of the data structures and processes of an automated centralized token service capable of implementing aspects of the invention.

### DETAILED DESCRIPTION

The invention encompasses an independent, centralized token service (CTS). Per the requests of registered users, the CTS generates, distributes, and authenticates random transaction keys. Users may designate the recipient(s) of a key, as well as dictate parameters of its contents and use. Users (individual or many) may bi-directionally initiate and exchange keys with each other (individual or many) for use in a wide variety of transactions and/or as a means of identification, authentication, and/or authorization. Multiple keys may be generated and exchanged for a single transaction. Further, keys may be exchanged, amongst all parties, for use in transactions involving fourth parties (individual or many).

The CTS is preferably fully automated using digital computing technologies, and users may access the CTS through various means such as an Internet-connected device (i.e. computer, smart phone, etc.) or telephone. The CTS provides for secure login via methodologies such as two-factor authentication (i.e. registered device recognition, voice recognition, etc.) and established sessions (i.e. authenticated secure channel, bulletin board posting, etc.). A variety of algorithms are employed by the CTS to generate the random transaction keys. The transaction keys themselves may be encrypted. The CTS monitors and reports all activity to each user. The reports serve as an audit trail for the user, and the monitoring may include the detecting and reporting of abnormal activity.

A user may be an individual or a client entity such as a corporate enterprise. All users must register with the CTS. A user may register independently or a user may be enrolled by a registered client of which the user is associated. The identity of a user may be authenticated through various identification methods and means of information, i.e. voluntary submission, client submission, public and private databases, etc. The CTS may store this user identification information. Activity permissions may be assigned to a user based on the certainty of the identity authentication.

Preferably if a user's identity needs to be authenticated, only the minimum information necessary for identity authentication is known by the CTS. Information beyond this minimum, such as sensitive client-user account information, need not be known. Further, any information known by the CTS can be stored “offsite”, physically separated from the main operations of the CTS.

Each user has a primary identifier and may also have plural alias identifiers associated with the primary identifier. For example, an identifier created with the user enrollment by a client may be mapped to the user's primary identifier. The primary identifier is known by the CTS, but may not be known by other users. A primary or alias identifier is necessary for transaction key recipient designation. A primary or alias identifier is required by the CTS for authentication in conjunction with an associated transaction key.

In addition to recipient designation, transaction key contents and use parameters may be dictated, enabling users to engage in a versatile variety of transactions. User requests for various parameters such as character type, key length, expiration, use allowances, transaction types, transaction designation, etc. can be accommodated by the CTS. For example, a user can request the CTS to generate a random generic one-time transaction key, or a random transaction key, designated “Transaction1”, that consists of 8 alphanumeric characters, to be used by “User A” and “User F”, a maximum of 3 times over a period of 48 hours. If necessary, the transaction key can be further customized to return output such as an image, barcode, etc. Regardless of any customization, the CTS employs a variety of generation algorithms and internal parameters to ensure a key is both random and unique at any one time.

Typically, the exchange of transaction keys (generation and authentication through the CTS) is a means to enter into a transaction. Users essentially “shake hands” with a key exchange, and thereby agree to a proposed transaction. The transaction itself is conducted separately from the CTS. The CTS does not know, store, or process any information of the transaction, nor act as its clearinghouse. However, the CTS may develop custom applications and specific processes which enable users to conduct various transactions within the CTS. Fourth party applications may be integrated into the CTS to facilitate transactions within and separate from the CTS. Finally, additional services, separate from transaction key generation and authentication (i.e. data mining, advertising, etc.), may be offered by the CTS.

### EXAMPLES

Operation and utility of the invention can be understood through illustrative examples. Consider first a new way to provide an electronic signature using the invention. Currently, the IRS has difficulty proving the identity of the person submitting an electronically filed (e-file) return, and the federal government loses billions of dollars each year from resulting fraudulent tax returns. The IRS could receive and authenticate a transaction key as a means of identity authentication.

Sally wants to e-file her 2012 tax return with the IRS. She logs in to the CTS, and after the CTS confirms her identity, she requests a transaction key: recipient (IRS); transaction type (E-File Signature). The CTS generates and returns the key to her. Sally submits her tax return electronically along with her CTS identifier and key to the IRS. The IRS receives the return and then submits a request to the CTS to authenticate (1) Sally generated an IRS E-File Signature key, and (2) the key is identically the key provided by Sally. CTS sends confirmation to the IRS, which can now process the return in the confidence that the person e-filing the return is truly Sally.

Similarly, Neil and Jane want to e-file their 2012 married joint tax return with the IRS. The IRS requires their two electronic signatures. Neil logs in to the CTS and requests a transaction for two users with separate transaction keys: recipient (IRS); transaction type (E-File Signature); transaction ID (“2012 Joint Return”); linked user (“Jane”). The CTS generates and returns a key to Neil. The CTS notifies Jane that she has an open transaction “2012 Joint Return” from “Neil”. Jane logs in to the CTS and requests a transaction key for linked transaction ID “2012 Joint Return”: recipient (IRS); transaction type (E-File Signature); transaction ID (“2012 Joint Return”); linked user (“Neil”). The CTS generates and returns a key to Jane. Neil submits their tax return electronically along with their CTS identifiers and two keys to the IRS. The IRS receives the return and then submits a single request to the CTS to authenticate (1) Neil generated an IRS E-File Signature key, (2) Jane generated an IRS E-File Signature key and (3) the keys are identically the keys provided by Neil and Jane. CTS sends confirmation to the IRS, which can now process the return in the confidence that the persons e-filing the return are truly Neil and Jane.

An example of an authorization and fourth party transaction is a money wire transfer, where a bank needs authorization from both the sender and receiver. Tom owes Kathy $500, and they agree to a money transfer through their shared Bank. Tom logs in to CTS, and generates a transaction key: recipient (Bank); linked user (Kathy); transaction type (Wire Transfer); use parameter (One-Time). Kathy logs in to the CTS, and generates a transaction key: recipient (Bank); linked user (Tom); transaction type (Wire Transfer); user parameter (One-Time). Tom logs in to the Bank website, and submits his key with the request to send a one-time $500 wire transfer to Kathy's account. The Bank holds the request until Kathy submits her key. Kathy logs in to the Bank website, submits her key with the request to receive a one-time $500 wire transfer from Tom's account. The Bank submits both keys and their enrolled user CTS identifiers to the CTS for authentication. The CTS returns confirmation to the Bank, which then completes the wire transfer.

A final example includes an exchange involving distribution and multiple transaction keys in which the CTS passes information securely on behalf of the users. Rob wants to encrypt a document and email it to Mary. Rob logs in to the CTS and requests the generation of a transaction key for an encryption password with a transaction key for linked user distribution: recipient (“Mary”); transaction ID (“EncryptDoc”); transaction type (Encryption Password); 2nd transaction type (Linked User Distribution). The CTS generates and returns the keys to Rob: 8H2359 (Encryption Password Key); 4218 (Distribution Key). Rob, using a fourth party application, encrypts and saves the document with the Encryption Password Key “8H2359” as its password. He emails the document to Mary with instructions to obtain the password from the CTS, using the Distribution Key “4218”. Mary logs in to the CTS and sees an open transaction “EncryptDoc” from “Rob”. She enters the Distribution Key “4218” and the CTS returns the Encryption Password Key “8H2359” to her. Mary can now open the document with this password.

Note that the interception of the Distribution Key by another party does not compromise security, as only Sally can gain access to the Encryption Password Key through her CTS account. Also, if the fourth party encryption application is integrated with the CTS, advanced use parameters could be added to the exchange. For example, Rob could require that the document only be viewed within the application itself and dictate that the CTS only return the Encryption Password Key to Mary “2 Times” over a “48 Hour” period. With Mary's retrieval of the Encryption Password Key, the CTS reporting and notification could confirm “Document Viewed” to both Rob and Mary.

### Notable Advantages:

As evident by the summary and examples described, the invention has notable advantages. A user does not have to possess or maintain facilities for generating or authenticating transaction keys. No specific technology requirements are imposed on the user, and a user may log in to the CTS through various technologies. A single user primary identifier may be used for all transactions with all users. All existing token system scalability barriers are removed.

While users need to have registered and established a relationship with the CTS before the process begins, there need be no prior relationship between the users themselves. Thus users do not need to store information specific to each other. Any user may initiate a transaction, enabling bi-directional key exchange. Exchanges may include multiple parties and multiple transaction keys. Users may be an individual, entities such as a corporation, or fourth parties.

The CTS is independent and resides centrally offsite to any user. This eliminates a user's internal hacking risk and exposure to external hacking is drastically reduced. CTS hacking exposure is limited as it may only store minimum user identification information, and storage of that information may be offsite. When transaction keys are unique to transactions, even if they are intercepted, they are of little to no value to hackers. A hacker must have several pieces of information to succeed, and even then the CTS monitoring and reporting provide a strong early warning system.

Custom transaction key generation and recipient designation enable a versatile variety of transactions. Typically, the transaction themselves are conducted separate from the CTS. This separation guarantees privacy and control remain with the users.

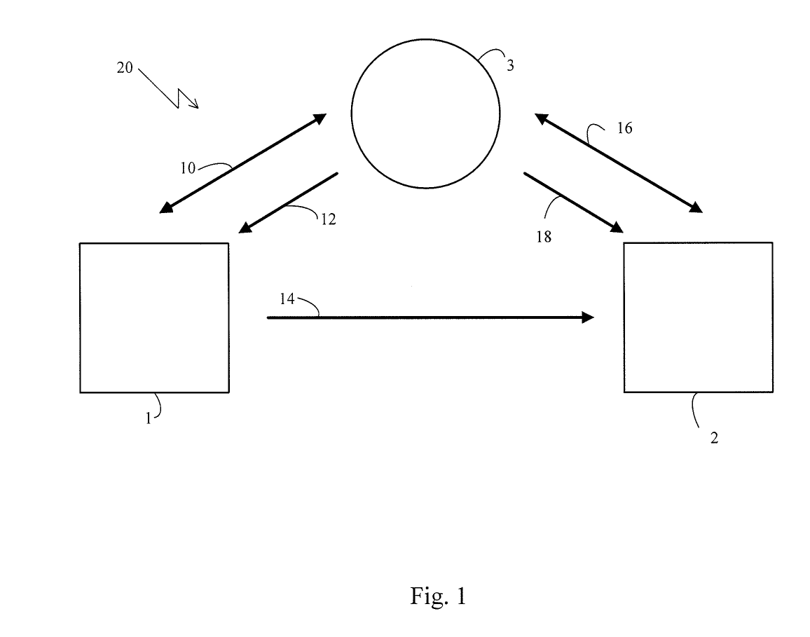

FIG. 1 depicts the interactions of two parties in a system 20 implementing a multi-step process for effecting transaction key generation, exchange, and authentication using a third-party centralized token service in accordance with a certain embodiment of the invention. For convenience, the steps are labeled A-F in the text below.

### Step A

In the first step, an originator 1 logs into a centralized token service (CTS) 3 via an originator dialogue 10. Typically, dialogue 10 would begin with originator 1 providing the CTS 3 a primary identifier and a password. The CTS 3 would then present a challenge to originator 1, which originator 1 must answer correctly. Such a challenge may take the form of a user-specific security question, e.g., asking the originator 1 to identify an image presented or to provide a previously established answer to the challenge, etc. A second security factor, such as a requirement that communications from the originator 1 are coming from a registered physical location or device, is typically required.

Step A may optionally further consist of the originator 1 requesting the generation of one or more transaction keys from the CTS 3. In addition, the originator may specify a receiver 2 for whom the transaction key is to be generated and other parameters of the transaction key.

### Step B

If the CTS 3 is satisfied with the outcome of Step A, it will respond with a transmission 12 containing one or more transaction keys for use by the originator 1. The CTS may store one or more transaction keys for later retrieval or authentication by the receiver 2.

### Step C

The originator 1 sends a transmission 14 to the receiver 2. Transmission 14 will typically contain a transaction key which originator 1 has obtained from the CTS 3. Additionally, transmission 14 will contain one or more identifiers of originator 1 and information pertaining to a transaction that originator 1 is requesting.

### Step D

Receiver 2 then logs into the CTS 3 via a receiver dialogue 16. Typically, dialogue 16 would begin with receiver 2 providing a CTS primary identifier and a password. The CTS 3 may then require a second security factor or present a challenge to receiver 2, which receiver 2 must answer correctly. Dialogue 16 additionally includes a request for authentication of an identifier referring to originator 1 matching a transaction key provided by originator 1 to receiver 2.

### Step E

If the CTS 3 is satisfied with the login of receiver 2, it will then respond to the authentication request with a transmission 18 either confirming or denying authenticity based upon the combination of the identifier of originator 1 and the transaction key. In deciding whether to confirm or deny the authenticity, the CTS 3 may take other information into account, such as, for example, the time of the request for authentication and the identity of the receiver.

Confirmation by the CTS 3 may also include providing a transaction key to receiver 2 in transmission 18. This transaction key, for instance, may be employed by the receiver in completing a transaction requested by originator 1.

### Step F

Lastly, if receiver 2 is satisfied by the answer from the CTS 3, receiver 2 may respond to the request for a transaction from originator 1. Typically, the transaction itself is conducted separately from the CTS 3. Alternatively, the CTS can complete the transaction.

It is important to note that any user of the CTS may act as an originator or a receiver in a given transaction. Also an originator or receiver may be an individual user or a group of users acting as a single party for the purposes of a particular transaction. In such a case, each individual user may be required to provide a separate input into a step of the process. For instance, several users may have to log in to approve the request to initiate a transaction, or the generation of a transaction key, or the like.

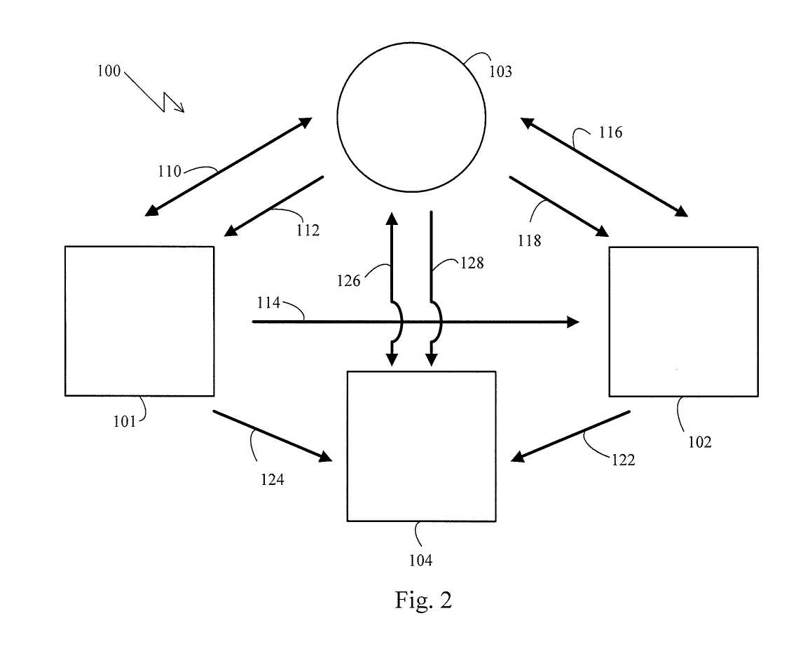

FIG. 2 depicts interactions of two parties in a system 100 implementing a multi-step process for effecting transaction key generation, exchange, and authentication using a third-party CTS in accordance with a certain other embodiment of the invention wherein a fourth party assists in completing the transaction. For convenience, the steps are labeled A-J in the text below.

### Step A

In the first step, an originator 101 sends a transmission 114 to a receiver 102. Typically, transmission 114 will contain one or more identifiers of originator 101 and information pertaining to a transaction that originator 101 is requesting with receiver 102 in conjunction with fourth party 104.

### Step B

Originator 101 logs into the CTS 103 via an originator dialogue 110. Typically, dialogue 110 would begin with originator 101 providing a CTS primary identifier and a password. The CTS 103 would then present a challenge to originator 101, which originator 101 must answer correctly. Such a challenge may take the form of a user-specific security question, e.g., asking the originator 101 to identify an image presented or to provide a previously established answer to the challenge, etc. A second security factor, such as a requirement that communications from the originator 101 are coming from a registered physical location or device, is typically required.

Step B may optionally further consist of the originator 101 requesting the generation of one or more transaction keys from the CTS 103. In addition, the originator may specify a receiver 102 and a fourth party 104 for whom the transaction key is to be associated and generated, and other parameters of the transaction key.

### Step C

If the CTS 103 is satisfied with the outcome of Step A, it will respond with a transmission 112 containing one or more transaction keys for use by the originator 101. The CTS may store one or more transaction keys for later retrieval or authentication by the receiver 102 and fourth party 104.

### Step D

Receiver 102 logs into the CTS 103 via a receiver dialogue 116. Typically, dialogue 116 would begin with receiver 102 providing a CTS primary identifier and a password. The CTS 103 would then present a challenge to receiver 102, which receiver 102 must answer correctly. Such a challenge may take the form of a user-specific security question, e.g., asking the receiver 102 to identify an image presented or to provide a previously established answer to the challenge, etc. A second security factor, such as a requirement that communications from the receiver 102 are coming from a registered physical location or device, is typically required.

Step D may optionally further consist of the receiver 102 requesting the generation of one or more transaction keys from the CTS 103. In addition, the originator may, separate from or in accordance with the primary transaction key generation request initiated by originator 101, specify an originator 101 and a fourth party 104 for whom the transaction key is to be associated and generated, and other parameters of the transaction key.

### Step E

If the CTS 103 is satisfied with the outcome of Step D, it will respond with a transmission 118 containing one or more transaction keys for use by the receiver 102. The CTS may store one or more transaction keys for later retrieval or authentication by the fourth party 104.

### Step F

The originator 101 sends a transmission 124 to the fourth party 104. Transmission 124 will typically contain a transaction key which originator 101 has obtained from the CTS 103. Additionally, transmission 124 will contain one or more identifiers of originator 101 and information pertaining to a transaction that originator 101 is requesting in conjunction with receiver 102.

### Step G

The receiver 102 sends a transmission 122 to the fourth party 104. Transmission 122 will typically contain a transaction key which receiver 102 has obtained from the CTS 103. Additionally, transmission 122 will contain one or more identifiers of receiver 102 and information pertaining to a transaction that receiver 102 is requesting in conjunction with originator 101.

### Step H

Fourth party 104 then logs into the CTS 103 via a fourth party dialogue 126. Typically, dialogue 126 would begin with fourth party 104 providing a CTS primary identifier and a password. The CTS 103 may then require a second security factor or present a challenge to fourth party 104, which fourth party 104 must answer correctly. Dialogue 126 additionally includes a request for authentication of identifiers referring to originator 101 and receiver 102 matching transaction keys separately provided by originator 101 and receiver 102 to fourth party 104.

### Step I

If the CTS 103 is satisfied with the login of fourth party 104, it will then respond to the authentication request with a transmission 128 either confirming or denying authenticity based upon the combination of the identifier of originator 101 and receiver 102 and the transaction keys. In deciding whether to confirm or deny the authenticity, the CTS 103 may take other information into account, such as, for example, the time of the request for authentication and the identity of the fourth party.

### Step J

Lastly, if fourth party 104 is satisfied by the answer from the CTS 103, fourth party 104 may respond to the request for a transaction from originator 101 and receiver 102. Typically, the transaction itself is conducted separately from the CTS 103. Alternatively, the CTS can complete the transaction.

It is important to note that any user of the CTS may act as an originator, a receiver, or a fourth party in a given transaction. Also an originator, receiver, or fourth party may each be an individual or a group of users acting as a single party for the purposes of a particular transaction.

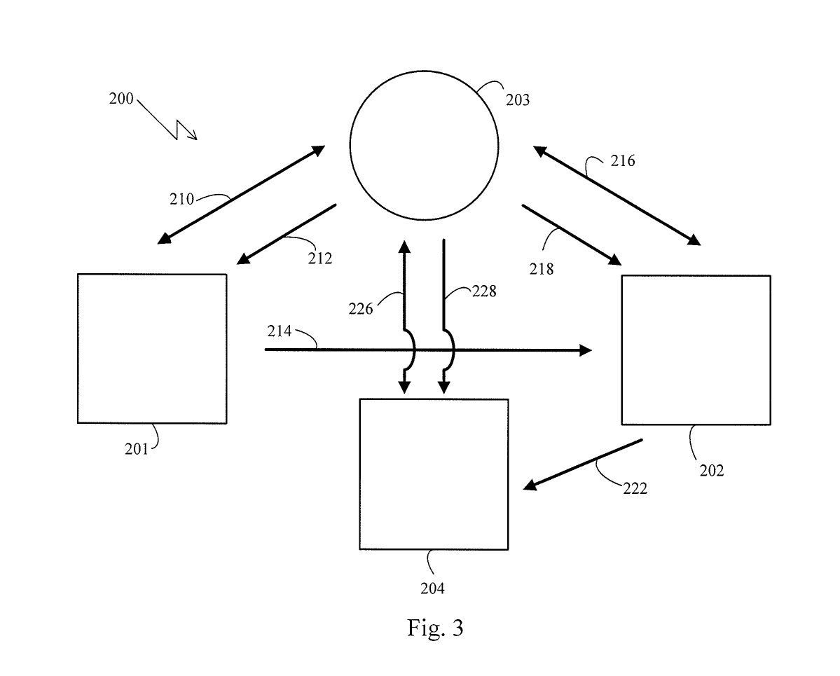

FIG. 3 depicts interactions of two parties in a system 200 implementing a multi-step process for effecting transaction key generation, exchange, and authentication using a third-party CTS in accordance with a certain other embodiment of the invention wherein a fourth party assists in completing the transaction.

For convenience, the steps are labeled A-I in the text below.

### Step A

In the first step, an originator 201 logs into the CTS 203 via an originator dialogue 210. Typically, dialogue 210 would begin with originator 201 providing a primary identifier and a password. The CTS 203 would then present a challenge to originator 201, which originator 201 must answer correctly. Such a challenge may take the form of a user-specific security question, e.g., asking the originator 201 to identify an image presented or to provide a previously established answer to the challenge, etc. A second security factor, such as a requirement that communications from the originator 201 are coming from a registered physical location or device, is typically required.

Step A may optionally further consist of the originator 201 requesting the generation of one or more transaction keys from the CTS 203. In addition, the originator may specify a receiver 202 and a fourth party 204 for whom the transaction key is to be associated and generated, and other parameters of the transaction key.

### Step B

If the CTS 203 is satisfied with the outcome of Step A, it will respond with a transmission 212 containing one or more transaction keys for use by the originator 201. The CTS may store one or more transaction keys for later retrieval or authentication by the receiver 202 and fourth party 204.

### Step C

Originator 201 sends a transmission 214 to the receiver 202. Typically, transmission 214 will contain one or more identifiers of originator 201, a transaction key which originator 201 has obtained from the CTS 203, and information pertaining to a transaction that originator 201 is requesting with receiver 202 in conjunction with fourth party 204.

### Step D

Receiver 202 logs into the CTS 203 via a receiver dialogue 216. Typically, dialogue 216 would begin with receiver 202 providing a primary identifier and a password. The CTS 203 would then present a challenge to receiver 202, which receiver 202 must answer correctly. Such a challenge may take the form of a user-specific security question, e.g., asking the receiver 202 to identify an image presented or to provide a previously established answer to the challenge, etc. A second security factor, such as a requirement that communications from the receiver 202 are coming from a registered physical location or device, is typically required.

Step D may optionally further consist of the receiver 202 requesting the generation of one or more transaction keys from the CTS 203. In addition, the receiver may, separate from or in accordance with the primary transaction key generation request initiated by originator 201, specify an originator 201 and a fourth party 204 for whom the transaction key is to be associated and generated, and other parameters of the transaction key.

### Step E

If the CTS 203 is satisfied with the outcome of Step D, it will respond with a transmission 218 containing one or more transaction keys for use by the receiver 202. The CTS may store one or more transaction keys for later retrieval or authentication by the fourth party 204.

### Step F

The receiver 202 sends a transmission 222 to the fourth party 204. Transmission 222 will typically contain a transaction key which receiver 202 has obtained from the CTS 203 and a transaction key which receiver 202 obtained from originator 201. Additionally, transmission 222 will contain one or more identifiers of receiver 202 and originator 201 and information pertaining to a transaction that receiver 202 is requesting in conjunction with originator 201.

### Step G

Fourth party 204 then logs into the CTS 203 via a fourth party dialogue 226. Typically, dialogue 226 would begin with fourth party 204 providing a CTS primary identifier and a password. The CTS 203 may then require a second security factor or present a challenge to fourth party 204, which fourth party 204 must answer correctly. Dialogue 226 additionally includes a request for authentication of identifiers referring to originator 201 and receiver 202 matching transaction keys provided by receiver 202 to fourth party 204.

### Step H

If the CTS 203 is satisfied with the login of fourth party 204, it will then respond to the authentication request with a transmission 228 either confirming or denying authenticity based upon the combination of the identifier of originator 201 and receiver 202 and the transaction keys. In deciding whether to confirm or deny the authenticity, the CTS 203 may take other information into account, such as, for example, the time of the request for authentication and the identity of the fourth party.

### Step I

Lastly, if fourth party 204 is satisfied by the answer from the CTS 203, fourth party 204 may respond to the request for a transaction from receiver 202 in conjunction with originator 201. Typically, the transaction itself is conducted separately from the CTS 203. Alternatively, the CTS can complete the transaction.

It is important to note that any user of the CTS may act as an originator, receiver, or fourth party in a given transaction. Also an originator, receiver, or fourth party may each be an individual or a group of users acting as a single party for the purposes of a particular transaction.

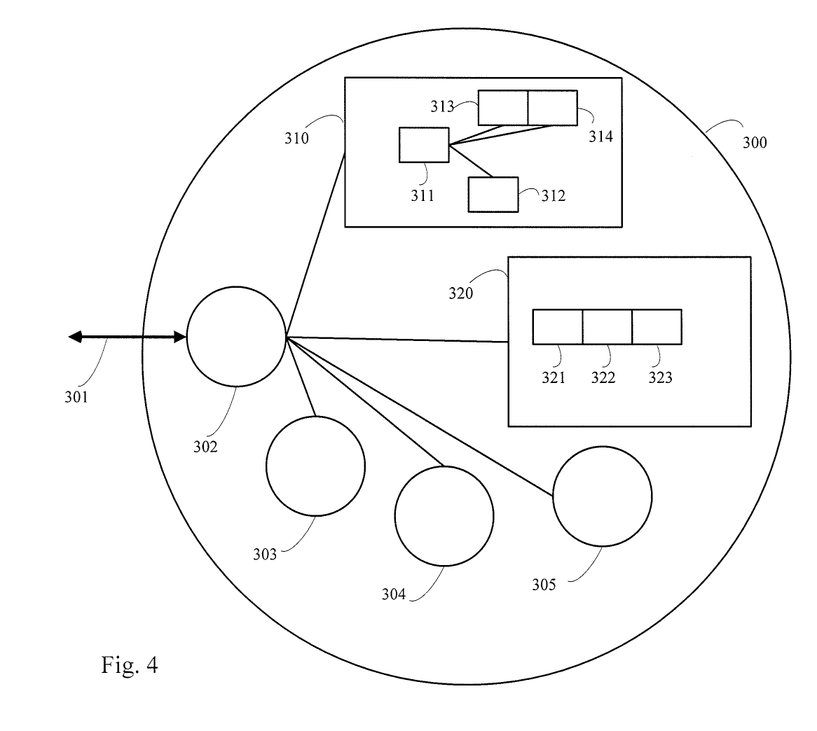

FIG. 4 depicts an illustrative set of data structures and processes for implementing certain aspects of the invention. CTS 300 is preferably implemented as one or nodes of a digital communications network such as the Internet, made up of digital computer hardware including processor and memory, input and output devices, database structures, and appropriate software coding. Communications with each user is established through portal 301 and controlled by a session process 302. A user database 310 contains user primary identifier 311. Associated with user primary identifier 311 may be one or more security questions or identification factors 312. Optionally associated with user primary identifier 311 are one or more alternative user alias identifiers 313 and 314. Available to session process 302 are a variety of tools which may include, for instance, a transaction key generator 303, a security factor processor 304, and a custom application 305. Additional memory 320 may contain such related groupings as, for example, an identifier of a first user requesting a transaction 321, an identifier of a second user with whom the transaction is requested 322, and an item of data 323, which may be a transaction key, which the first user wishes to share with the second user.

The practitioner will appreciate that the concepts of the invention have many uses beyond those outlined above. To name just a few, uses include identity authentication, transaction authorization, and electronic signature. Secure electronic voting for political, corporate or commercial purposes could also be achieved, for example, where a fourth party would provide the electronic voting application, and the voter registrar and the individual voter would submit keys from the CTS separately, which are then verified by the voting application using the CTS.

All the users of the CTS may be communicating via machine-to-machine digital computing means. However, this does not always have to be the case. Portions of system may involve analog and/or human interfaces. For instance, identity authentication login via a telephone may be accomplished in part, for example, using voice recognition.

The flexible inventive architecture allows any user to assume any of the roles of, e.g., originator, receiver, authorizing party, confirming party, or fulfillment party, etc. Thus the CTS may be used to authenticate transactions online which are initiated by any party. This has myriad of implications in the legal field. The CTS could be useful, for example, in facilitating online notary services, certified litigation document production, proof of the presentation of documents, witness services, and online service of legal process to individuals or their registered agents, to name but a few applications where forensic proof of online communications may be required.

The invention may employ standard methods for secure financial transactions such as random credit card CVV code generation. The use of CTS-generated single-use or “sticky codes”—i.e., codes useful for only one or a few transactions—have many applications. For instance, a supervisor may use the CTS to enable an employee to use a credit card or other account only for limited purposes or a limited time, allowing the supervisor to delegate the setting of transaction details to the employee.

We claim:

1. A method for automating transaction key generation, exchange, and authentication comprising the following steps:
A. an originator logging into a centralized token service by using a first user primary identifier and associated password, and correctly answering a first challenge presented by the centralized token service, and requesting a first transaction key from the centralized token service by, naming a receiver and specifying a first set of parameters for a first transaction key;
B. the centralized token service generating a first transaction key according to the first set of parameters and transmitting the first transaction key to the originator;
C. the originator transmitting an alias identifier and the first transaction key to the receiver and requesting a transaction;
D. the receiver logging into the centralized token service by using a second user primary identifier and associated password, and answering a second challenge, and making a request for authentication, the request comprising the alias identifier and the first transaction key;
E. the centralized token service confirming or denying the authenticity based upon a combination of the identifiers and the first transaction key; and
F. the receiver completing the transaction separate from the centralized token service.

2. The method in claim 1 wherein at least one of said originator or receiver comprises plural individual users and more than one user login is required to complete at least one of Steps A and D.

3. The method in claim 1 wherein any user of the centralized token service may act as the originator or the receiver for the transaction.

4. The method of claim 1 the centralized token service may be used for one or more applications selected from the list including: identity authentication; transaction authorization; electronic signature; electronic voting; identity authentication login via the internet; identity authentication login via the telephone; secure document transfer; secure password transfer; secure document, file, and/or folder cloud storage; document, file, and or folder encryption; banking services and wire transfers; payment authorization and confirmation; random credit card CVV code generation; online notary services; online witness services; online process server; online registered agent services; document, file, and/or folder delivery confirmation; transaction completion confirmation; transaction activity audit services; transaction delegation; sticky code transactions; or transaction key encryption.

5. The method of claim 1 wherein the alias identifier is identical to the first user primary identifier.

6. The method of claim 1 comprising the additional steps of the centralized token service storing a parcel of data at the request of the originator and the receiver obtaining the parcel upon presentation of a parcel identifier.

7. The method of claim 1 wherein the centralized token service fulfills the transaction.

8. A method for automating transaction key generation, exchange, and authentication comprising the following steps:
A. an originator transmitting a first alias identifier to a receiver and requesting a transaction in conjunction with a fourth party
B. the originator logging into a centralized token service by using a first user primary identifier and associated password, and correctly answering a first challenge presented by the centralized token service, and requesting a first transaction key from the centralized token service by, naming a receiver and associated fourth party and specifying a first set of parameters for the first transaction key;
C. the centralized token service generating the first transaction key according to the first set of parameters and transmitting the first transaction key to the originator;
D. the receiver logging into the centralized token service by using a second user primary identifier and associated password, and correctly answering a second challenge presented by the centralized token service, and requesting a second transaction key from the centralized token service by naming the originator and the associated fourth party and specifying a second set of parameters for the second transaction key;
E. the centralized token service generating the second transaction key according to the second set of parameters and transmitting the second transaction key to the receiver;
F. the originator transmitting the first alias identifier and the first transaction key to the associated fourth party and requesting a transaction;
G. the receiver transmitting a second alias identifier and the second transaction key to the associated fourth party and requesting the transaction;
H. the associated fourth party logging into the centralized token service by using a third user primary identifier and associated password, and answering a third challenge, and making a request for authentication, the request comprising of first and second alias identifiers and the first and second transaction keys;
I. the centralized token service confirming or denying the authenticity based upon a combination of the alias identifiers and the transaction keys; and
J. the associated fourth party completing the transaction separate from the centralized token service.

9. The method in claim 8 wherein at least one of said originator, receiver, or fourth party comprises plural individual users and more than one user login is required to complete at least one of Steps B, D and H.

10. The method in claim 8 wherein any user of the centralized token service may act as the originator, receiver, or fourth party for the transaction.

11. The method of claim 8 wherein the centralized token service may be used for one or more applications selected from the list including: identity authentication; transaction authorization; electronic signature; electronic voting; identity authentication login via the internet; identity authentication login via the telephone; secure document transfer; secure password transfer; secure document, file, and/or folder cloud storage; document, file, and or folder encryption; banking services and wire transfers; payment authorization and confirmation; random credit card CVV code generation; online notary services; online witness services; online process server; online registered agent services; document, file, and/or folder delivery confirmation; transaction completion confirmation; transaction activity audit services; transaction delegation; sticky code transactions; or transaction key encryption.

12. The method of claim 8 wherein the alias identifier is identical to the first user primary identifier.

13. The method of claim 8 comprising the additional steps of the centralized token service storing a parcel of data at the request of the originator and the receiver obtaining the parcel upon presentation of a parcel identifier.

14. The method of claim 8 wherein the centralized token service fulfills the transaction.

15. A method for automating transaction key generation, exchange, and authentication comprising the following steps:
A. an originator logging into a centralized token service by using a user primary identifier and associated password, and correctly answering a first challenge presented by the centralized token service, and requesting a first transaction key from the centralized token service by, naming a receiver and an associated fourth party and specifying a first set of parameters for the first transaction key;
B. the centralized token service generating the first transaction key according to the first set of parameters and transmitting the first transaction key to the originator;
C. the originator transmitting a first alias identifier and the first transaction key to the receiver and requesting a transaction in conjunction with the associated fourth party;
D. the receiver logging into the centralized token service by using a second user primary identifier and associated password, and correctly answering a second challenge presented by the centralized token service, and requesting a second transaction key from the centralized token service by naming the first alias identifier and the associated fourth party and specifying a second set of parameters for the second transaction key;
E. the centralized token service generating the second transaction key according to the second set of parameters and transmitting the second transaction key to the receiver;
F. the receiver transmitting the first alias identifier, a second alias identifier, and the first and second transaction keys to the associated fourth party and requesting the transaction;
G. the associated fourth party logging into the centralized token service by using a third user primary identifier and associated password, and answering a third challenge, and making a request for authentication, the request comprising of the first and second alias identifiers and the first and second transaction keys;
H. the centralized token service confirming or denying the authenticity based upon a combination of the alias identifiers and the transaction keys; and
I. the associated fourth party completing the transaction separate from the centralized token service.

16. The method in claim 15 wherein the originator, receiver, or fourth party comprises plural individual users and more than one user login is required to complete at least one of Steps A, D and G.

17. The method in claim 15 wherein any user of the centralized token service may act as the originator, receiver, or fourth party for the transaction.

18. The method of claim 15 wherein the centralized token service may be used for one or more applications selected from the list including: identity authentication; transaction authorization; electronic signature; electronic voting; identity authentication login via the internet; identity authentication login via the telephone; secure document transfer; secure password transfer; secure document, file, and/or folder cloud storage; document, file, and or folder encryption; banking services and wire transfers; payment authorization and confirmation; random credit card CVV code generation; online notary services; online witness services; online process server; online registered agent services; document, file, and/or folder delivery confirmation; transaction completion confirmation; transaction activity audit services; transaction delegation; sticky code transactions; or transaction key encryption.

19. The method of claim 15 wherein the alias identifier is identical to the first user primary identifier.

20. The method of claim 15 comprising the additional steps of the centralized token service storing a parcel of data at the request of the originator and the receiver obtaining the parcel upon presentation of a parcel identifier.

21. The method of claim 15 wherein the centralized token service fulfills the transaction.

22. A centralized token service for facilitating transaction key generation, exchange, and authentication comprising:
a digital computer connected to a digital communications network, the digital computer comprising including a digital computer processor and a memory, input and output devices, and software, wherein the digital computer is configured to:
provide a secure login to an originator;
generate a first transaction key according to a set of parameters provided by the originator, and provide the first transaction key to the originator;
provide a secure login to a receiver;
confirm or deny the authenticity of a second transaction key provided by the receiver based on whether the second transaction key is identical to the first transaction key provided to the originator and whether the receiver properly identifies the originator;
generate a second transaction key according to a set of parameters provided by the receiver, and provide the second transaction key to the receiver;
provide a secure login to a fourth party; and
confirm or deny the authenticity of a first and second transaction key provided by the fourth party based on whether the first and second transaction keys are identical to the first transaction key provided to the originator and the second transaction key provided to the receiver and whether the fourth party properly identifies the originator and receiver.
